(19) United States
(12) Patent Application Publication
(10) Pub. No.: US 2024/0249224 A1
(43) Pub. Date: Jul. 25, 2024

(54) TIME DETERMINING DEVICE, TIME DETERMINING METHOD, AND NON-TRANSITORY COMPUTER-READABLE STORAGE MEDIUM STORING COMPUTER PROGRAM

(71) Applicant: SUMITOMO ELECTRIC INDUSTRIES, LTD., Osaka-shi, Osaka (JP)

(72) Inventors: Yu URATA, Osaka-shi (JP); Tomoyuki KITADA, Osaka-shi (JP); Shigeki NISHIMURA, Osaka-shi (JP); Norio KOREKAWA, Osaka-shi (JP)

(73) Assignee: SUMITOMO ELECTRIC INDUSTRIES, LTD., Osaka-shi, Osaka (JP)

(21) Appl. No.: 18/289,907

(22) PCT Filed: Apr. 13, 2022
(86) PCT No.: PCT/JP2022/017699

§ 371 Date: Nov. 8, 2023

(30) Foreign Application Priority Data
Jul. 9, 2021 (JP) 2021-113934

(51) Int. Cl. G06Q 10/0631; G06Q 10/083

(52) U.S. Cl. CPC G06Q 10/06314; G06Q 10/083

(57) ABSTRACT

A time determining device includes a plan information acquiring unit configured to acquire plan information indicating a scheduled standby time and a scheduled work time of a worker in a predetermined area, a travel record information acquiring unit configured to acquire travel record information including a travel position and a travel time of a vehicle in which the worker rides, and a time determining unit configured to determine, based on the plan information and the travel record information, a standby record time and a work record time of the worker in the predetermined area.

### TECHNICAL FIELD

The present disclosure relates to a time determining device, a time determining method and a computer program product.

This application claims priority based on Japanese Patent Application No. 2021-113934 filed on Jul. 9, 2021, and the entire contents of the Japanese patent application are incorporated herein by reference.

### BACKGROUND ART

Conventionally, a delivery planning system is known which plans a delivery route of a package to a delivery destination, a scheduled arrival time, a scheduled stay time at the delivery destination, and the like. The scheduled stay time includes a scheduled standby time and a scheduled work time at the delivery destination after the arrival at the delivery destination.

When such a delivery plan is unreasonable, a mechanism for analyzing the cause and improving the delivery plan to a new delivery plan is required. For cause analysis, it is necessary to accurately determine a standby record time and a work record time of a worker at the delivery destination.

In order to determine the work record time, PTL 1 discloses that a worker presses an operation state input switch to input a work state such as unloading or resting. PTL 2 discloses that a worker uses an information terminal to input information related to a cargo handling state.

### CITATION LIST

### Patent Literature

PTL 1: Japanese Unexamined Patent Application Publication No. 2005-251073

PTL 2: Japanese Unexamined Patent Application Publication No. 2019-28979

### SUMMARY OF INVENTION

A time determining device according to an aspect of the present disclosure includes, a plan information acquiring unit configured to acquire plan information indicating a scheduled standby time and a scheduled work time of a worker in a predetermined area, a travel record information acquiring unit configured to acquire travel record information including a travel position and a travel time of a vehicle in which the worker rides, and a time determining unit configured to determine, based on the plan information and the travel record information, a standby record time and a work record time of the worker in the predetermined area.

A time determining method according to another aspect of the present disclosure includes, acquiring, by a time determining device, plan information indicating a scheduled standby time and a scheduled work time of a worker in a predetermined area, acquiring, by the time determining device, travel record information including a travel position and a travel time of a vehicle in which the worker rides, and determining, by the time determining device, based on the plan information and the travel record information, a standby record time and a work record time of the worker in the predetermined area.

A computer program according to another aspect of the present disclosure causes a computer to function as, a plan information acquiring unit configured to acquire plan information indicating a scheduled standby time and a scheduled work time of a worker in a predetermined area, a travel record information acquiring unit configured to acquire travel record information including a travel position and a travel time of a vehicle in which the worker rides, and a time determining unit configured to determine, based on the plan information and the travel record information, a standby record time and a work record time of the worker in the predetermined area.

It is needless to say that such a computer program can be distributed via a computer-readable non-transitory recording medium such as a CD-ROM (compact disc-read only memory) or a communication network such as the Internet. In addition, the present disclosure can be realized as a semiconductor integrated circuit that realizes a part or all of the time determining device, or can be realized as a system including the time determining device.

### BRIEF DESCRIPTION OF THE DRAWINGS

FIG. 1 is a diagram showing an overall configuration of a schedule/record management system according to an embodiment of the present disclosure.

FIG. 2 is a diagram showing an example of delivery plan information created by a delivery plan creating device.

FIG. 3 is a diagram for explaining a delivery plan of a package indicated by a delivery plan information in comparison with a travel record of a vehicle 4 indicated by a travel record information.

FIG. 4 is a block diagram showing a configuration of a schedule/record analyzing device.

FIG. 5 is a diagram for explaining a method of determining an arrival time to a predetermined area and a departure time from the predetermined area by a stop determining unit.

FIG. 6 is a diagram showing an example of stop time information in a delivery destination “ABC001” determined by the stop determining unit.

FIG. 7 is a diagram showing an example of a stop position of a vehicle on a map.

FIG. 8 is a diagram for explaining a method of determining a standby record time and a work record time.

FIG. 9 is a flowchart showing an example of a processing procedure of a schedule/record analyzing device 3.

### DETAILED DESCRIPTION

### Problems to be Solved by Present Disclosure

However, in the methods described in PTLs 1 and 2, the worker must input information about the work using a switch or a terminal. Therefore, the worker is burdened with input. In addition, when an input omission or an input error by the worker occurs, the work record time cannot be accurately determined.

The present disclosure has been made in view of such circumstances, and an object thereof is to provide a time determining device, a time determining method, and a computer program capable of accurately determining a standby record time and a work record time without burdening the user with information input.

### [Advantageous Effects of Present Disclosure]

According to the present disclosure, it is possible to accurately determine the standby record time and the work record time without burdening the user with information input.

### Outline of Embodiments of Present Disclosure

First, the outline of embodiments of the present disclosure is listed and described. (1) A time determining device according to an embodiment of present disclosure includes, a plan information acquiring unit configured to acquire plan information indicating a scheduled standby time and a scheduled work time of a worker in a predetermined area, a travel record information acquiring unit configured to acquire travel record information including a travel position and a travel time of a vehicle in which the worker rides, and a time determining unit configured to determine, based on the plan information and the travel record information, a standby record time and a work record time of the worker in the predetermined area.

According to this configuration, it is possible to determine the standby record time and the work record time based on the plan information and the travel record information.

(2) The time determining device according to claim 1, the time determining unit includes, a stop determining unit configured to determine, based on the travel record information, a plurality of stop positions of the vehicle in the predetermined area and a plurality of stop times of the vehicle, and a work record time determining unit configured to determine, among the plurality of stop times, a stop time closest to the scheduled work time as the work record time.

According to this configuration, it is possible to accurately associate the scheduled work time indicated in the plan information with the stop time in the predetermined area. Therefore, the work record time can be accurately determined.

(3) The time determining device according to claim 1, the time determining unit includes, a stop determining unit configured to determine, based on the travel record information, a plurality of stop positions of the vehicle in the predetermined area and a plurality of stop times of the vehicle, and a standby record time determining unit configured to determine, among the plurality of stop times, a stop time closest to the scheduled standby time as the standby record time.

According to this configuration, it is possible to accurately associate the scheduled standby time indicated in the plan information with the stop time in the predetermined area. Therefore, the standby record time can be accurately determined.

(4) In addition, the time determining unit may include, a stop determining unit configured to determine, based on the travel record information, a plurality of stop positions of the vehicle in the predetermined area and a plurality of stop times of the vehicle, a work record time determining unit configured to determine, among the plurality of stop times, a stop time closest to the scheduled work time as the work record time, and a standby record time determining unit configured to determine, among the plurality of stop times, a stop time closest to the scheduled standby time as the standby record time.

According to this configuration, it is possible to accurately associate the scheduled standby time and the scheduled work time indicated in the plan information with the stop time in the predetermined area. Therefore, it is possible to accurately determine the standby record time and the work record time.

(5) In addition, the time determining unit may further include, a temporary stop time determining unit configured to determine, among the plurality of stop times, a stop time less than a predetermined time threshold as a temporary stop time of the vehicle.

According to this configuration, since the short stop time can be determined as the temporary stop time, it is possible to prevent the short stop time from being associated with the scheduled standby time and the scheduled work time.

(6) In addition, the work record time determining unit may be configured to determine the standby record time from among the plurality of stop times excluding the stop time determined as the work record time.

According to this configuration, it is possible to prioritize the association of the scheduled work time over the association of the scheduled standby time. As a result, even when the scheduled standby time and the scheduled work time are included in the plan information but the worker performs only work without standing by in the predetermined area for the reason that there is no time to stand by or the like, it is possible to accurately determine the work record time.

(7) In addition, the time determining unit may further include, a first classifying unit configured to classify the plurality of stop times into any of the standby record time and the work record time in accordance with an order of the scheduled standby time and the scheduled work time indicated by the plan information if the scheduled standby time and the scheduled work time are equal.

When the scheduled standby time and the scheduled work time are equal to each other, the stop time equal to those can be associated with both the scheduled standby time and the scheduled work time. Therefore, the standby record time and the work record time can be accurately determined by classifying the plurality of stop times in accordance with the order of standby and work indicated by the plan information.

(8) In addition, the time determining unit may further include, a second classifying unit configured to classify a plurality of stop times having an equal time length into any of the standby record time and the work record time in accordance with an order of the scheduled standby time and the scheduled work time indicated by the plan information if the plurality of stop times include the plurality of stop times having an equal time length.

When the plurality of stop times include a plurality of stop times having the equal time length, the plurality of stop times having the equal time length can be associated with one scheduled standby time or one scheduled work time. Therefore, the standby record time and the work record time can be accurately determined by classifying the plurality of stop times having the equal time length in accordance with the order of standby and work indicated by the plan information.

(9) A time determining method according to another aspect of the present disclosure includes, acquiring, by a time determining device, plan information indicating a scheduled standby time and a scheduled work time of a worker in a predetermined area, acquiring, by the time determining device, travel record information including a travel position and a travel time of a vehicle in which the worker rides, and determining, by the time determining device, based on the plan information and the travel record information, a standby record time and a work record time of the worker in the predetermined area.

This configuration includes the processing in the time determining device described above as steps. Therefore, according to this configuration, it is possible to achieve the operations and effects similar to those of the above-described time determining device.

(10) A computer program according to another embodiment of the present disclosure causes a computer to function as, a plan information acquiring unit configured to acquire plan information indicating a scheduled standby time and a scheduled work time of a worker in a predetermined area, a travel record information acquiring unit configured to acquire travel record information including a travel position and a travel time of a vehicle in which the worker rides, and a time determining unit configured to determine, based on the plan information and the travel record information, a standby record time and a work record time of the worker in the predetermined area.

According to this configuration, the computer can function as the above-described time determining device. Therefore, the operations and effects similar to those of the time determining device described above can be achieved.

### Details of Embodiments of Present Disclosure

Embodiments of the present disclosure will now be described with reference to the drawings. It should be noted that each of the embodiments described below indicates a specific example of the present disclosure. Numerical values, shapes, materials, constituent elements, arrangement positions and connection forms of constituent elements, steps, order of steps, and the like shown in the following embodiments are examples, and do not limit the present disclosure. In addition, among the constituent elements in the following embodiments, constituent elements not recited in the independent claims are constituent elements that can be arbitrarily added. In addition, each drawing is a schematic diagram and is not necessarily strictly illustrated.

Moreover, the same components are denoted by the same reference numerals. Since their functions and names are the same, their descriptions are omitted as appropriate.

### [Overall Configuration of Schedule/Record Management System]

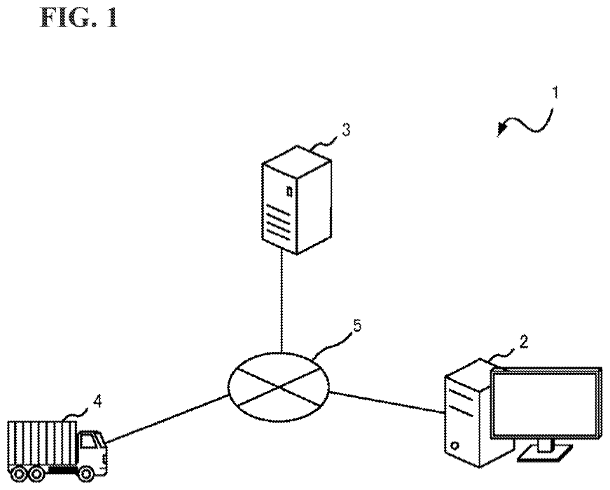

FIG. 1 is a diagram showing an overall configuration of a schedule/record management system according to an embodiment of the present disclosure; Referring to FIG. 1, a schedule/record management system 1 is a system for managing delivery plan information indicating a delivery plan of packages by a vehicle 4 and travel record information indicating a travel record of vehicle 4, and includes a delivery plan creating device 2, a schedule/record analyzing device 3 which is a time determining device, and vehicle 4. Delivery plan creating device 2 is a device for creating delivery plan information of packages by vehicle 4.

Schedule/record analyzing device 3 detects a temporal difference between the delivery plan and the travel record based on the delivery plan information created by delivery plan creating device 2 and the travel record information of vehicle 4, and analyzes a cause of the temporal difference based on the detection result. Schedule/record analyzing device 3 transmits the analysis result to delivery plan creating device 2. Upon receiving the analysis result, delivery plan creating device 2 corrects the next and subsequent delivery plan information on the basis of the analysis result.

Vehicle 4 is a vehicle used by a worker to deliver packages, and is, for example, a lorry such as a truck or a van. Vehicle 4 includes a position determination unit for determining the position of vehicle 4 and a speed meter for measuring the speed of vehicle 4. The position determination unit determines the position of vehicle 4 using satellite navigation. For example, the position determination unit determines the position of vehicle 4 based on radio waves received from a plurality of GPS (global positioning system) satellites. The position of vehicle 4 can be determined by, for example, latitude and longitude. The satellite navigation uses a satellite positioning system of the GPS, but is not limited thereto, and may use a satellite positioning system such as Michibiki or Galileo. These satellite positioning systems are collectively referred to as a GNSS (global navigation satellite system).

Delivery plan creating device 2, schedule/record analyzing device 3, and vehicle 4 are connected to a network 5 such as the Internet in a wired or wireless manner and can transmit and receive data to and from each other.

### Example of Delivery Plan Information

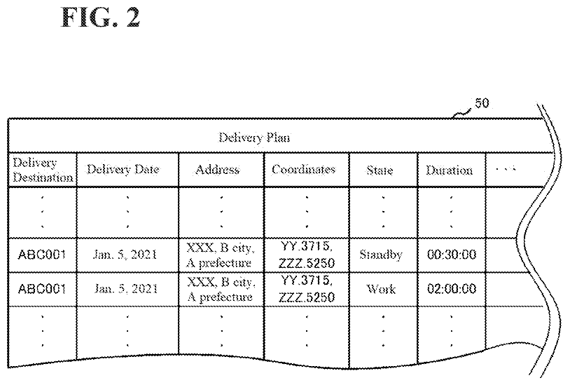

FIG. 2 is a diagram showing an example of delivery plan information created by delivery plan creating device 2. Referring to FIG. 2, a delivery plan information 50 includes information on a delivery destination of a package, a delivery date, an address of the delivery destination, coordinates of the delivery destination, a state of the worker at the delivery destination, and a duration of the state. For example, delivery plan information 50 indicates that the package is delivered to the delivery destination “ABC001” on “Jan. 5, 2021”. In addition, delivery plan information 50 indicates that the address of the delivery destination is “A prefecture, B city XXX” and the coordinates (latitude, longitude) of the delivery destination are “YY. 3715, ZZZ. 5250”. Further, delivery plan information 50 indicates that the worker waits for 30 minutes at the delivery destination “ABC001” and then works for 2 hours.

Delivery plan information 50 also includes information such as a travel route to the delivery destination “ABC001” and a scheduled departure time at a departure point. Delivery plan information 50 does not include detailed information of a point where the worker is working or a point where the worker is standing by in the delivery destination “ABC001”.

### [Comparison Between Delivery Plan and Travel Record]

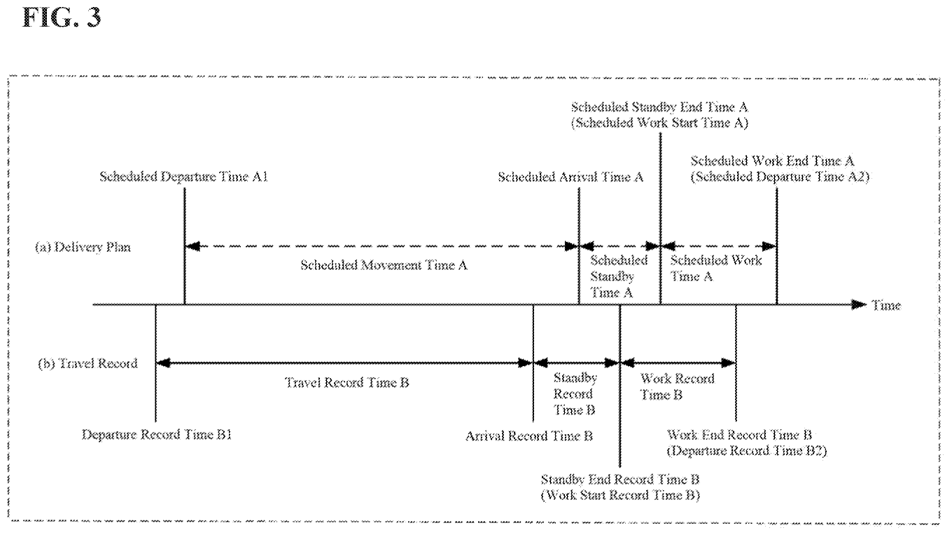

FIG. 3 is a diagram for explaining the delivery plan (a) of the package indicated by the delivery plan information in comparison with the travel record (b) of vehicle 4 indicated by the travel record information.

According to the delivery plan (a) in FIG. 3, vehicle 4 departs from the departure point at the scheduled departure time A1 and arrives at the delivery destination at a scheduled arrival time A after a scheduled movement time A. Then, vehicle 4 stands by at the delivery destination for a scheduled standby time A from the scheduled arrival time A to a scheduled standby end time A, and performs work such as loading or unloading at the delivery destination for a scheduled work time A from the scheduled standby end time A (that is, a scheduled work start time A) to a scheduled work end time A. Thereafter, vehicle 4 departs from the delivery destination at the scheduled work end time A (that is, a scheduled departure time A2) and heads to the next delivery destination.

According to the travel record (b) in of FIG. 3, vehicle 4 departed from the departure point at a departure record time B1 and arrived at the delivery destination at an arrival record time B after the elapse of a travel record time B. Then, vehicle 4 waited at the delivery destination for a standby record time B from the arrival record time B to a standby end record time B, and performed work such as loading and unloading at the delivery destination for a work record time B from the standby end record time B (that is, a work start record time B) to a work end record time B. Thereafter, vehicle 4 departed from the delivery destination at the work end record time B (that is, a departure record time B2) and headed to the next delivery destination.

Schedule/record analyzing device 3 compares each time of the delivery plan with each time of the travel record, or compares each time in the delivery plan with each time in the travel record to analyze the cause when the delivery is not performed according to the delivery plan. For example, when the work record time B is shorter than the scheduled work time A, schedule/record analyzing device 3 analyzes whether the cause is a delay in the travel or a delay in the standby, or the like. In order to perform such analysis, it is necessary to accurately determine the arrival record time B at the delivery destination, and the standby record time B and the work record time B at the destination.

### [Configuration of Schedule/Record Analyzing Device 3]

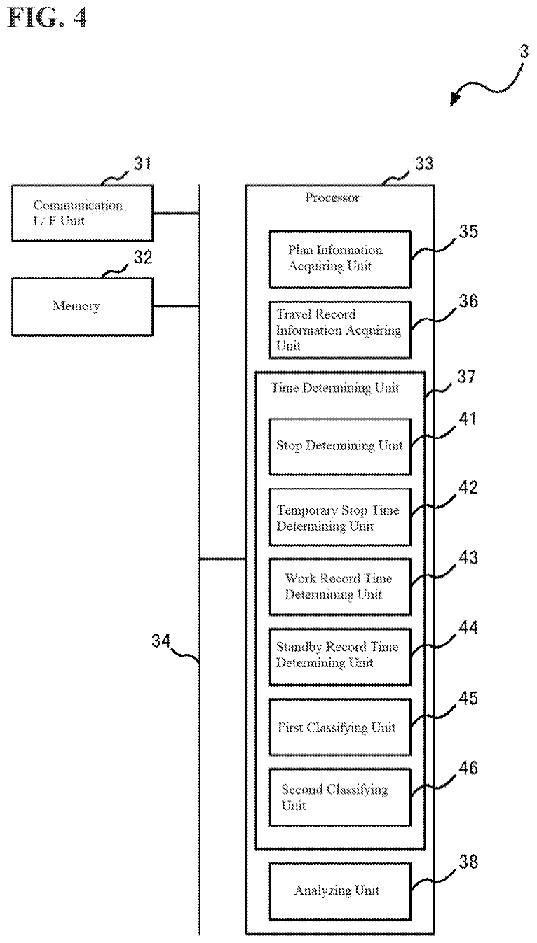

FIG. 4 is a block diagram showing the configuration of schedule/record analyzing device 3. Referring to FIG. 4, schedule/record analyzing device 3 includes a communication I/F (interface) unit 31, a memory 32, and a processor 33 which are connected to each other via a bus 34. Communication I/F unit 31 includes a communication module for performing wired or wireless communication with an external device.

Memory 32 is configured by a volatile memory element such as a SRAM (static random access memory) or a DRAM (dynamic random access memory), a nonvolatile memory element such as a flash memory or an EEPROM (electrically erasable programmable read only memory), or a magnetic storage device such as a hard disk. Memory 32 stores a computer program executed by processor 33. Moreover, memory 32 stores data used when the computer program is executed and data generated when the computer program is executed.

Processor 33 is configured by a CPU (central processing unit) or the like, and includes a plan information acquiring unit 35, a travel record information acquiring unit 36, a time determining unit 37, and an analyzing unit 38 as functional processing units realized by executing a computer program stored in memory 32.

Plan information acquiring unit 35 acquires delivery plan information 50 of vehicle 4 from delivery plan creating device 2 via communication I/F unit 31. Plan information acquiring unit 35 stores acquired delivery plan information 50 in memory 32. An example of delivery plan information 50 is shown in FIG. 2 and includes the scheduled standby time and the scheduled work time of the worker in the predetermined area in which the delivery destination is included.

Travel record information acquiring unit 36 periodically acquires the travel record information including a travel position, a travel time, and a driving speed of vehicle 4 from vehicle 4 via communication I/F unit 31. Travel record information acquiring unit 36 stores the acquired travel record information in memory 32.

Time determining unit 37 determines the standby record time and the work record time of the worker in the predetermined area based on the delivery plan information acquired by plan information acquiring unit 35 and the travel record information acquired by travel record information acquiring unit 36.

Time determining unit 37 includes a stop determining unit 41, a temporary stop time determining unit 42, a work record time determining unit 43, a standby record time determining unit 44, a first classifying unit 45, and a second classifying unit 46.

Stop determining unit 41 determines a plurality of stop positions of vehicle 4 in the predetermined area and a stop time of vehicle 4 at each stop position based on the travel record information acquired by travel record information acquiring unit 36.

Specifically, stop determining unit 41 determines the arrival time of vehicle 4 to the predetermined area and the departure time from the predetermined area based on the travel record information.

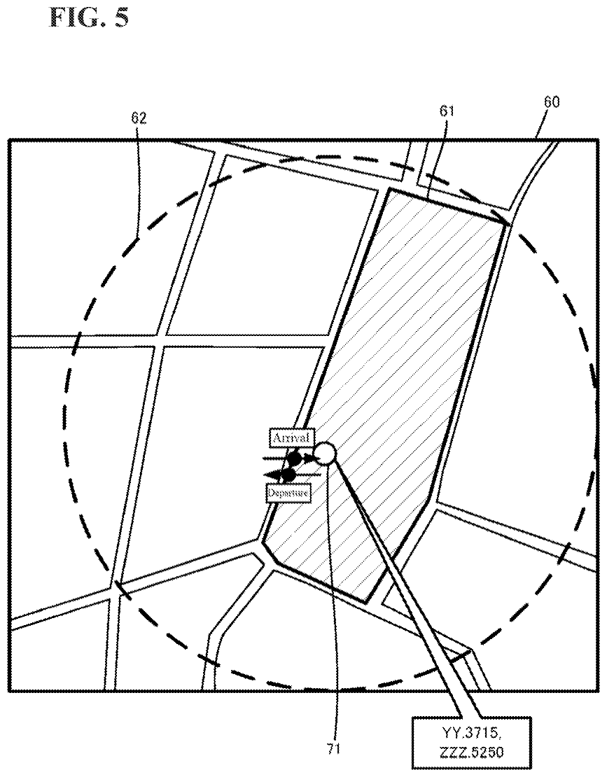

FIG. 5 is a diagram for explaining a method of determining the arrival time to the predetermined area and the departure time from the predetermined area by stop determining unit 41. FIG. 5 shows a map 60 showing a geofence 61 of the area which contains the delivery destination “ABC001”. Geofence 61 is determined from the map information and the address of the delivery destination “ABC001” indicated in delivery plan information 50. Stop determining unit 41 calculates the minimum time and the maximum time of the travel time based on the travel record information including the travel position in geofence 61 among the travel record information stored in memory 32. Stop determining unit 41 determines the minimum time of the travel time as the arrival record time to the delivery destination “ABC001”, and determines the maximum time of the travel time as the departure record time from the delivery destination “ABC001”.

When the exact area of the delivery destination “ABC001” cannot be determined like geofence 61, stop determining unit 41 may set an area as a geofence 62 based on a first point 71 indicated by the coordinates (here, the coordinates (YY. 3715, ZZZ. 5250) consisted of movement and longitude) of the delivery destination “ABC001” indicated in delivery plan information 50. For example, stop determining unit 41 determines an area within X meters from first point 71 to be geofence 62. Stop determining unit 41 determines a travel time at which the driving speed firstly becomes zero as the arrival record time to the delivery destination “ABC001” and determines a travel time at which the driving speed lastly becomes zero as the departure record time from the delivery destination “ABC001” based on the travel record information which contains the travel positions in geofence 62. It should be noted that the shape of geofence 62 is not limited to a circular shape, and may be another shape such as an elliptical shape or a polygonal shape including a quadrangular shape.

Further, the driving speed may not be included in the travel record information. In this case, stop determining unit 41 calculates the driving speed from the plurality of travel times and the travel position at each travel time.

Based on the travel record information between the arrival record time and the departure record time, stop determining unit 41 determines a position at which the driving speed becomes zero as the stop position of vehicle 4 between the actual arrival record time and the actual departure record time, and determines a time at which the driving speed is zero at the stop position as the stop time of vehicle 4.

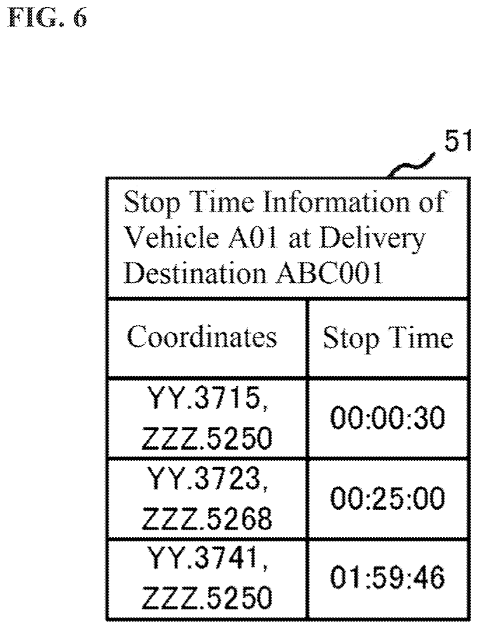

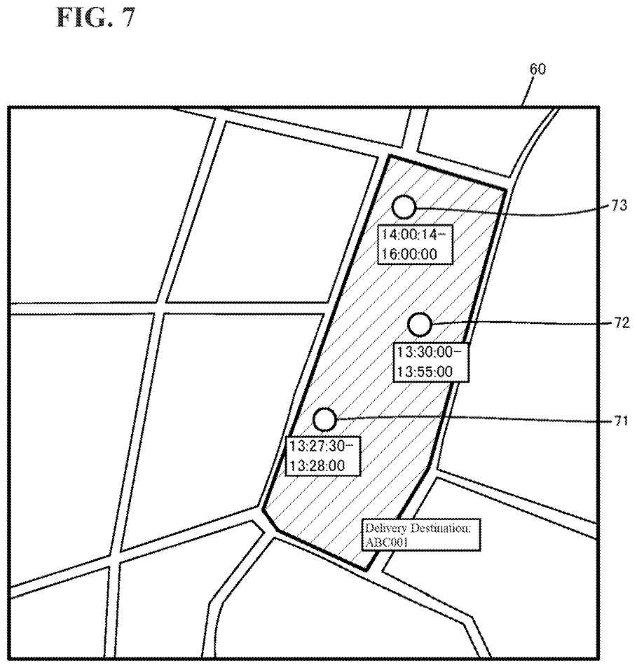

FIG. 6 is a diagram showing an example of stop time information in the delivery destination “ABC001” determined by stop determining unit 41. A stop time information 51 indicates stop positions and stop times of vehicle 4. FIG. 7 is a diagram showing an example of the stop positions of vehicle 4 on map 60. For example, it is indicated that vehicle 4 stopped at first point 71 designated by the coordinates (YY. 3715, ZZZ. 5250) for 30 seconds from 13: 27: 30 to 13: 28: 00. In addition, it is indicated that vehicle 4 stopped at a second point 72 designated by the coordinates (YY. 3723, ZZZ. 5268) for 25 minutes from 13: 30: 00 to 13: 55: 00. Further, it is indicated that vehicle 4 stopped at a third point 73 designated by the coordinates (YY 3741, ZZZ. 5250) for 1 hour 59 minutes 46 seconds from 14: 00: 14 to 16: 00: 00.

Referring again to FIG. 4, temporary stop time determining unit 42 determines, among the plurality of stop times determined by stop determining unit 41, a stop time less than a predetermined time threshold as a temporary stop time of vehicle 4. For example, when the time threshold is set to 5 minutes, in the example shown in FIGS. 6 and 7, the stop time at the stop position of first point 71 designated by the coordinates (YY. 3715, ZZZ. 5250) is 30 seconds, which is less than 5 minutes. Therefore, temporary stop time determining unit 42 determines that the stop time of vehicle 4 at first point 71 is the temporary stop time.

Work record time determining unit 43 determines, among the plurality of stop times determined by stop determining unit 41, the stop time closest to the scheduled work time indicated by delivery plan information 50 as the work record time. More specifically, work record time determining unit 43 determines the stop time closest to the scheduled work time indicated by delivery plan information 50 as the work record time from among the stop times excluding the temporary stop times determined by temporary stop time determining unit 42 from among the plurality of stop times.

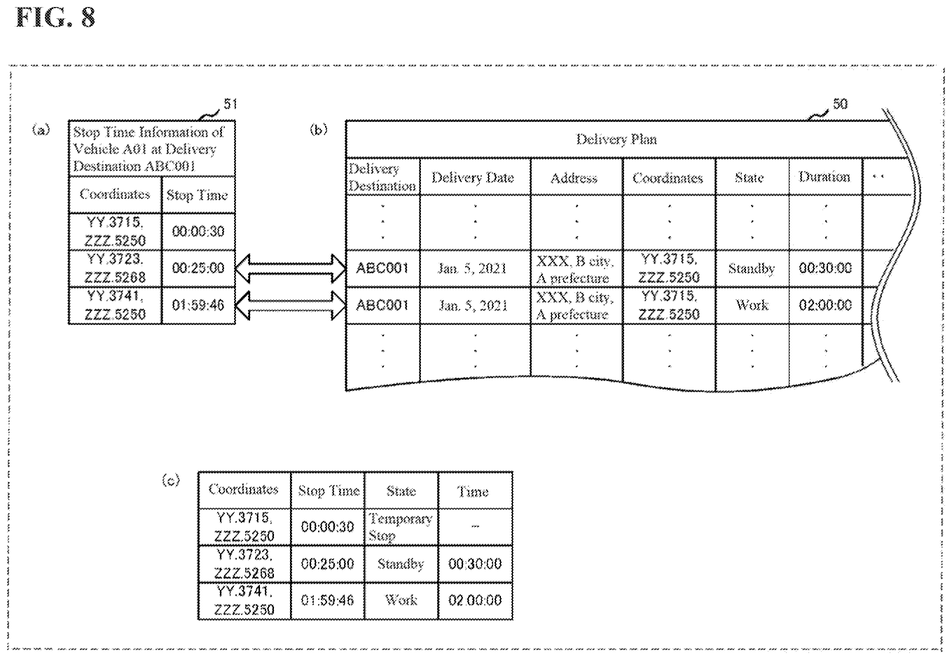

FIG. 8 is a diagram for explaining a method of determining a standby record time and a work record time. Part (b) of FIG. 8 shows the same delivery plan information 50 as shown in FIG. 2. Part (a) of FIG. 8 shows the same stop time information 51 as shown in FIG. 6. Work record time determining unit 43 determines the time “02: 00: 00” (2 hours) corresponding to the state “work” as the scheduled work time indicated by delivery plan information 50. Work record time determining unit 43 determines the stop time closest to the scheduled work time of 2 hours from stop time information 51. However, as shown in Part (c) of FIG. 8, 30 seconds determined as the temporary stop time by temporary stop time determining unit 42 is excluded from the candidates. Therefore, work record time determining unit 43 determines, among the stop times of 25 minutes and 1 hour 59 minutes 46 seconds, the latter which is closest to the scheduled work time of 2 hours, as the work record time. That is, work record time determining unit 43 determines that the stop time at third point 73 is the work record time.

Referring again to FIG. 4, standby record time determining unit 44 determines, among the plurality of stop times determined by stop determining unit 41, the stop time closest to the scheduled standby time indicated by delivery plan information 50 as the standby record time. More specifically, standby record time determining unit 44 determines the stop time closest to the scheduled standby time indicated by delivery plan information 50 as the standby record time from among the stop times excluding the temporary stop times determined by temporary stop time determining unit 42 from among the plurality of stop times.

Referring again to FIG. 8, for example, standby record time determining unit 44 determines the time “00: 30: 00” (30 minutes) corresponding to the state “standby” as the standby record time indicated by delivery plan information 50. Standby record time determining unit 44 determines the stop time closest to 30 minutes which is the scheduled standby time from stop time information 51. However, the 30 seconds determined as the temporary stop time by temporary stop time determining unit 42 is excluded from the candidates. Therefore, standby record time determining unit 44 determines, among the stop times of 25 minutes and 1 hour 59 minutes 46 seconds, the former which is closest to the scheduled standby time of 30 minutes, as the standby record time. That is, work record time determining unit 43 determines that the stop time at second point 72 is the standby record time.

Referring again to FIG. 4, first classifying unit 45 will now be described. When the scheduled standby time and the scheduled work time in one predetermined area indicated by delivery plan information 50 are equal to each other or a difference therebetween is smaller than a preset reference value, the same stop times may be associated with both the scheduled standby time and the scheduled work time. In order to perform the one-to-one association, first classifying unit 45 classifies the plurality of stop times into any one of the standby record time and the work record time according to an order of the scheduled standby time and the scheduled work time indicated by delivery plan information 50. For example, according to delivery plan information 50, it is assumed that the work is going to be performed after the standby, and both the scheduled standby time and the scheduled work time are one hour. In this case, first classifying unit 45 classifies, among the stop times excluding the temporary stop times among the plurality of stop times determined by stop determining unit 41, the temporally earlier stop time as the scheduled standby time, and classifies the later stop time as the scheduled work time.

Second classifying unit 46 will now be described. When the stop times in one predetermined area determined by stop determining unit 41 except the temporary stop times include a plurality of stop times having an equal time length or a plurality of stop times in which a difference is smaller than a preset reference value, the plurality of stop times having the same time length or the difference therebetween being smaller than the preset reference value may be associated with one scheduled standby time or one scheduled work time. In order to perform the one-to-one association, second classifying unit 46 classifies the plurality of stop times having the equal time length into any of the standby record time and the work record time in accordance with an order of the scheduled standby time and the scheduled work time indicated by delivery plan information 50. For example, it is assumed that there are two stop times of one hour. In addition, according to delivery plan information 50, it is assumed that the work is going to be performed after the standby. In this case, second classifying unit 46 classifies the stop time of the temporally preceding one hour as the scheduled standby time and classifies the temporally later stop time of one hour as the scheduled work time.

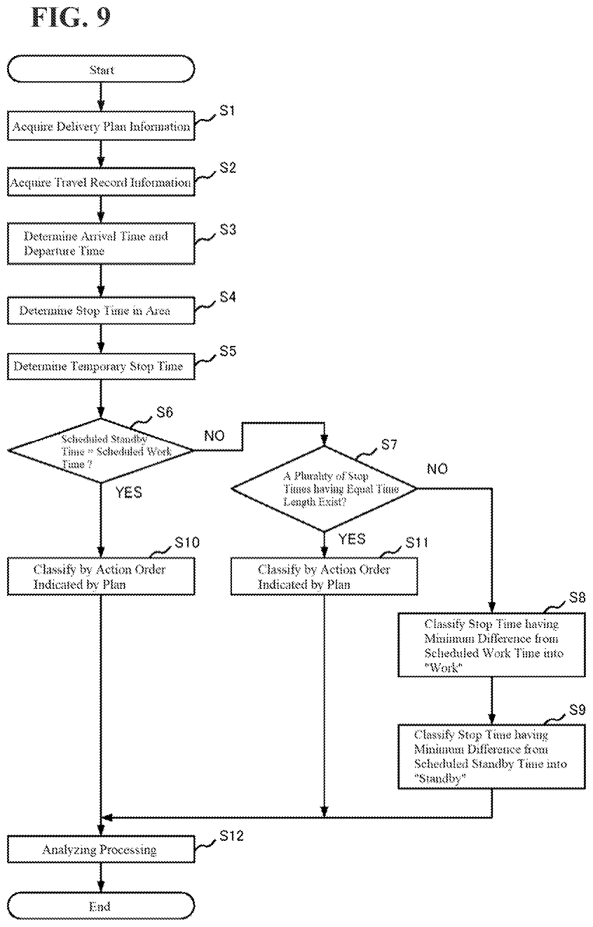

Analyzing unit 38 detects a temporal difference between the delivery plan and the travel record based on delivery plan information 50 and the time information related to the travel record of vehicle 4 determined by time determining unit 37, and analyzes a cause of the temporal difference based on the detection result.

[Processing Procedure of Schedule/Record Analyzing Device 3] FIG. 9 is a flowchart showing an example of a processing procedure of schedule/record analyzing device 3. Plan information acquiring unit 35 acquires the delivery plan information of vehicle 4 from delivery plan creating device 2 via communication I/F unit 31 (step S1).

Travel record information acquiring unit 36 periodically acquires the travel record information including the travel position, the travel time, and the driving speed of vehicle 4 from vehicle 4 via communication I/F unit 31 (step S2).

Stop determining unit 41 determines the arrival time of vehicle 4 to the predetermined area (delivery destination “ABC001”) and the departure time from the predetermined area based on the travel record information (step S3).

Stop determining unit 41 determines the stop times of vehicle 4 in the predetermined area based on the travel record information including the travel time between the arrival record time and the departure record time (step S4).

Temporary stop time determining unit 42 determines the stop time less than the predetermined time threshold among the stop times determined in step S4 as the temporary stop time of vehicle 4 (step S5).

First classifying unit 45 determines whether the scheduled standby time and the scheduled work time in one predetermined area indicated by delivery plan information 50 are equal to each other or not (step S6).

When the scheduled standby time and the scheduled work time are different from each other (NO in step S6), second classifying unit 46 determines whether or not there is a plurality of stop times having the equal time length or a plurality of stop times in which a difference of the time lengths is smaller than the preset reference value among the plurality of stop times excluding the temporary stop times in the predetermined area (step S7).

When a plurality of stop times having the equal time length or a plurality of stop times having a difference smaller than the preset reference value does not exist (NO in step S7), work record time determining unit 43 classifies, among the plurality of stop times determined by stop determining unit 41, the stop time closest to the scheduled work time indicated by delivery plan information 50 into the work record time (step S8). That is, work record time determining unit 43 determines the stop time closest to the scheduled work time as the work record time.

Standby record time determining unit 44 classifies, among the plurality of stop times excluding the temporary stop times in the predetermined area, the stop time closest to the scheduled standby time indicated by delivery plan information 50 into the standby record time (step S9). That is, standby record time determining unit 44 determines the stop time closest to the scheduled standby time as the standby record time.

When the scheduled standby time and the scheduled work time are equal (YES in step S6), first classifying unit 45 classifies the plurality of stop times excluding the temporary stop times into any of the standby record time and the work record time in accordance with the order of the scheduled standby time and the scheduled work time indicated by delivery plan information 50 (step S10). Accordingly, first classifying unit 45 determines the standby record time and the work record time.

When there exists stop times having the equal time length or a difference therebetween being smaller than the preset reference value among the plurality of stop times excluding the temporary stop times in the predetermined area (YES in step S7), second classifying unit 46 classifies the plurality of stop times excluding the temporary stop times into any of the standby record time and the work record time in accordance with the order of the scheduled standby time and the scheduled work time indicated by delivery plan information 50 (step S11). Accordingly, second classifying unit 46 determines the standby record time and the work record time.

After the processing of steps S9 to S11, analyzing unit 38 detects a temporal difference between the delivery plan and the travel record based on delivery plan information 50, the arrival time and the departure time determined in step S3, and the standby record time and the work record time classified in steps S9 to S11, and analyzes the cause of the temporal difference based on the detection result (step S12).

### [Advantageous Effects of Embodiments]

According to an embodiment of the present disclosure, time determining unit 37 can determine the standby record time and the work record time of the worker based on delivery plan information 50 and the travel record information. Here, the travel record information can be automatically acquired from a GPS receiver or the like mounted on vehicle 4. Therefore, it is possible to accurately determine the standby record time and the work record time without burdening the user who is the worker with information input.

In addition, time determining unit 37 can associate the stop times in the predetermined area with the scheduled standby time or the scheduled work time by comparing delivery plan information 50 with stop time information 51. Therefore, it is possible to accurately determine the standby record time and the work record time.

In addition, since temporary stop time determining unit 42 can determine the short stop time as the temporary stop time, the short stop time is not associated with the scheduled standby time or the scheduled work time.

In addition, when the scheduled standby time and the scheduled work time are equal, the stop times having the equal time length can be associated with both the scheduled standby time and the scheduled work time. Therefore, first classifying unit 45 classifies the plurality of stop times according to the order of standby and work indicated by delivery plan information 50. Thus, the standby record time and the work record time can be accurately determined.

When the plurality of stop times include a plurality of stop times having the equal time length or a plurality of stop times having a difference therebetween being smaller than the preset reference value, the plurality of stop times having the equal time length or the plurality of stop times having the difference smaller than the preset reference value can be associated with one scheduled standby time or one scheduled work time. Therefore, second classifying unit 46 classifies the plurality of stop times according to the order of standby and work indicated by delivery plan information 50. Thus, the standby record time and the work record time can be accurately determined.

It is preferable that standby record time determining unit 44 determines the standby record time (step S9 in FIG. 9) after work record time determining unit 43 determines the work record time (step S8 in FIG. 9). Thus, the association of the work record time can be executed in preference to the association of the standby record time. As a result, when the scheduled standby time and the scheduled work time are included in delivery plan information 50 but the worker performs only work without standing by in the predetermined area for the reason that there is no time for standby or the like, it is possible to accurately determine the work record time.

### [Supplementary Notes]

In the above-described embodiment, schedule/record management system 1 in the case where the worker performs the delivery work has been described, but the work performed by the worker is not limited to the delivery work. For example, the embodiment of the present disclosure can be applied to a case where vehicle 4 stands by at a certain point in a predetermined area, vehicle 4 is stopped at another point in the predetermined area, and a worker performs some work at the point.

In addition, in delivery plan information 50, work is performed after standby is performed, but standby may be performed after work is performed, or standby and work may be performed a plurality of times in the same predetermined area.

Some or all of the constituent elements constituting schedule/record analyzing device 3 may be constituted by one or more semiconductor devices such as system LSIs.

The computer program may be recorded on a non-transitory computer-readable recording medium such as an HDD, a CD-ROM, or a semiconductor memory and distributed. Further, the computer program may be transmitted and distributed via an electric communication line, a wireless or wired communication line, a network represented by the Internet, data broadcasting, or the like.

Schedule/record analyzing device 3 may be realized by a plurality of computers or a plurality of processors.

Some or all of the functions of schedule/record analyzing device 3 may be provided by cloud computing. That is, some or all of the functions of schedule/record analyzing device 3 may be realized by the cloud server.

The embodiments disclosed herein are to be considered in all respects as illustrative and not restrictive. The scope of the present disclosure is defined not by the above-described meaning but by the claims, and is intended to include all modifications within the meaning and scope equivalent to the claims.

### REFERENCE SIGNS LIST

1 schedule/record management system
2 delivery plan creating device
3 schedule/record analyzing device (time determining device)
4 vehicle
5 network
31 communication I/F unit
32 memory
33 processor
34 bus
35 plan information acquiring unit
36 travel record information acquiring unit
37 time determining unit
38 analyzing unit
41 stop determining unit
42 temporary stop time determining unit
43 work record time determining unit
44 standby record time determining unit
45 first classifying unit
46 second classifying unit
50 delivery plan information
51 stop time information
60 map
61 geofence
62 geofence
71 first point
72 second point
73 third point

1. A time determining device comprising:
a plan information acquiring circuit configured to acquire plan information indicating a scheduled standby time and a scheduled work time of a worker in a predetermined area;
a travel record information acquiring circuit configured to acquire travel record information including a travel position and a travel time of a vehicle in which the worker rides; and
a time determining circuit configured to determine, based on the plan information and the travel record information, a standby record time and a work record time of the worker in the predetermined area.

2. The time determining device according to claim 1, wherein
the time determining circuit comprises:
a stop determining circuit configured to determine, based on the travel record information, a plurality of stop positions of the vehicle in the predetermined area and a plurality of stop times of the vehicle; and
a work record time determining circuit configured to determine, among the plurality of stop times, a stop time closest to the scheduled work time as the work record time.

3. The time determining device according to claim 1, wherein
the time determining circuit comprises:
a stop determining circuit configured to determine, based on the travel record information, a plurality of stop positions of the vehicle in the predetermined area and a plurality of stop times of the vehicle; and
a standby record time determining circuit configured to determine, among the plurality of stop times, a stop time closest to the scheduled standby time as the standby record time.

4. The time determining device according to claim 1, wherein
the time determining circuit comprises:
a stop determining circuit configured to determine, based on the travel record information, a plurality of stop positions of the vehicle in the predetermined area and a plurality of stop times of the vehicle;
a work record time determining circuit configured to determine, among the plurality of stop times, a stop time closest to the scheduled work time as the work record time; and
a standby record time determining circuit configured to determine, among the plurality of stop times, a stop time closest to the scheduled standby time as the standby record time.

5. The time determining device according to claim 1, wherein
the time determining circuit comprises:
a temporary stop time determining circuit configured to determine, among the plurality of stop times, a stop time less than a predetermined time threshold as a temporary stop time of the vehicle.

6. The time determining device according to claim 2, wherein
the work record time determining circuit is configured to determine the standby record time from among the plurality of stop times excluding the stop time determined as the work record time.

7. The time determining device according to claim 2, wherein
the time determining circuit further comprises:
a first classifying circuit configured to classify the plurality of stop times into any of the standby record time and the work record time in accordance with an order of the scheduled standby time and the scheduled work time indicated by the plan information if the scheduled standby time and the scheduled work time are equal.

8. The time determining device according to claim 2, wherein
the time determining circuit further comprises:
a second classifying circuit configured to classify a plurality of stop times having an equal time length into any of the standby record time and the work record time in accordance with an order of the scheduled standby time and the scheduled work time indicated by the plan information if the plurality of stop times include the plurality of stop times having an equal time length.

9. A method of determining a time, the method comprising:
acquiring, by a time determining device, plan information indicating a scheduled standby time and a scheduled work time of a worker in a predetermined area;
acquiring, by the time determining device, travel record information including a travel position and a travel time of a vehicle in which the worker rides; and
determining, by the time determining device, based on the plan information and the travel record information, a standby record time and a work record time of the worker in the predetermined area.

10. A non-transitory computer-readable storage medium storing computer program for causing a computer to function as:
a plan information acquiring circuit configured to acquire plan information indicating a scheduled standby time and a scheduled work time of a worker in a predetermined area;
a travel record information acquiring circuit configured to acquire travel record information including a travel position and a travel time of a vehicle in which the worker rides; and
a time determining circuit configured to determine, based on the plan information and the travel record information, a standby record time and a work record time of the worker in the predetermined area.

11. The time determining device according to claim 2, wherein
the time determining circuit comprises:
a temporary stop time determining circuit configured to determine, among the plurality of stop times, a stop time less than a predetermined time threshold as a temporary stop time of the vehicle.

12. The time determining device according to claim 3, wherein
the time determining circuit comprises:
a temporary stop time determining circuit configured to determine, among the plurality of stop times, a stop time less than a predetermined time threshold as a temporary stop time of the vehicle.

13. The time determining device according to claim 4, wherein
the time determining circuit comprises:
a temporary stop time determining circuit configured to determine, among the plurality of stop times, a stop time less than a predetermined time threshold as a temporary stop time of the vehicle.

14. The time determining device according to claim 3, wherein
the time determining circuit further comprises:
a first classifying circuit configured to classify the plurality of stop times into any of the standby record time and the work record time in accordance with an order of the scheduled standby time and the scheduled work time indicated by the plan information if the scheduled standby time and the scheduled work time are equal.

15. The time determining device according to claim 4, wherein
the time determining circuit further comprises:
a first classifying circuit configured to classify the plurality of stop times into any of the standby record time and the work record time in accordance with an order of the scheduled standby time and the scheduled work time indicated by the plan information if the scheduled standby time and the scheduled work time are equal.

16. The time determining device according to claim 5, wherein
the time determining circuit further comprises:
a first classifying circuit configured to classify the plurality of stop times into any of the standby record time and the work record time in accordance with an order of the scheduled standby time and the scheduled work time indicated by the plan information if the scheduled standby time and the scheduled work time are equal.

17. The time determining device according to claim 3, wherein
the time determining circuit further comprises:
a second classifying circuit configured to classify a plurality of stop times having an equal time length into any of the standby record time and the work record time in accordance with an order of the scheduled standby time and the scheduled work time indicated by the plan information if the plurality of stop times include the plurality of stop times having an equal time length.

18. The time determining device according to claim 4, wherein
the time determining circuit further comprises:
a second classifying circuit configured to classify a plurality of stop times having an equal time length into any of the standby record time and the work record time in accordance with an order of the scheduled standby time and the scheduled work time indicated by the plan information if the plurality of stop times include the plurality of stop times having an equal time length.

19. The time determining device according to claim 5, wherein
the time determining circuit further comprises:
a second classifying circuit configured to classify a plurality of stop times having an equal time length into any of the standby record time and the work record time in accordance with an order of the scheduled standby time and the scheduled work time indicated by the plan information if the plurality of stop times include the plurality of stop times having an equal time length.
